(19) United States
(12) Patent Application Publication
(10) Pub. No.: US 2012/0274862 A1
(43) Pub. Date: Nov. 1, 2012

(54) Outdoor Television Antenna

(76) Inventors: Thomas Li, Monterey Park, CA (US); David Chuc, Monterey Park, CA (US)

(21) Appl. No.: 13/097,899

(22) Filed: Apr. 29, 2011

(51) Int. Cl. H04N 5/44; H01Q 3/02

(52) U.S. Cl. 348/734; 343/766; 348/725

(57) ABSTRACT

An outdoor television antenna includes VHF antenna elements, UHF antenna elements, reflector elements that are adapted to reflect broadcast signals, a rotation unit having a motor-fixed bolster and a main pole column, an antenna circuit that collects the VHF broadcast signals and the UHF broadcast signals and provides electric power to the rotation unit, a main body that supports the VHF antenna elements, the UHF antenna elements, the reflector elements and the motor-fixed bolster, and encloses the antenna circuit, a control unit that that relays the VHF and UHF broadcast signals and sends electric power to the antenna circuit, a remote controller that sends rotation control signal to the control unit, and a conductive cable that connects the control unit and the antenna circuit. The control circuit controls rotation of the rotation unit in response to the rotation control signal and the motor-fixed bolster rotates the main pole column with electric power delivered through the conductive cable.

### BACKGROUND OF THE INVENTION

1. Field of the Invention

The invention is related to an outdoor television antenna. More particularly, the present invention is related to an outdoor television antenna that is rotatable for best signal reception with an indoor remote controller.

2. Description of the Prior Art

Digital television broadcasting provides a variety of channels, does not need non-free subscription to channel providers, and does not need a designated hardware such as set top box. The quality of digital television viewing depends mainly on the strength of received broadcast signals. Design of an antenna greatly varies outcome in a given environment. In addition, in installed state, the direction of an antenna is very important to receive the maximum signal, and direction of an antenna should be frequently adjusted, which is time-consuming and very difficult especially for an outdoor antenna. Further, in nowadays product distribution, packaged size must be as small as possible to reduce transportation cost, which is difficult for a slender, elongated, and dispersed product such as a television antenna. An outdoor television antenna solving the problems has long been in need.

### SUMMARY OF THE INVENTION

An objective of the invention is to provide an outdoor television antenna, the installed direction of which can be adjusted remotely from indoor.

Another objective of the invention is to provide an outdoor television antenna having excellent reception and a compact size when it is packaged.

In order to achieve the objectives, the present invention provides an outdoor television antenna comprising one or more VHF antenna elements that are adapted to receive VHF broadcast signals, one or more UHF antenna elements that are adapted to receive UHF broadcast signals, a reflecting unit that is adapted to reflect broadcast signals, a rotation unit that comprises a motor-fixed bolster and a main pole column, wherein the main pole column is adapted to fix the outdoor television antenna to a main pole, an antenna circuit that collects the VHF broadcast signals and the UHF broadcast signals, and provides electric power to the rotation unit, a main body that supports the VHF antenna elements, the UHF antenna elements, the reflecting unit and the motor-fixed bolster, and encloses the antenna circuit, a control unit that relays the VHF and UHF broadcast signals and sends electric power to the antenna circuit, a remote controller that sends rotation control signal to the control unit and a conductive cable that connects the control unit and the antenna circuit and conducts the VHF and UHF broadcast signals and the electric power to power the rotation unit. The control unit controls rotation of the rotation unit, and the motor-fixed bolster rotates the main pole column.

The motor-fixed bolster comprises an electric motor that comprises a shaft, a housing that encloses the electric motor and comprises an opening, a disc support that is attached to the opening, a disc that rests upon the disc support and fixed to the shaft. The disc support comprises a circular aperture that receives the circumference, of the main pole column. The disc is fixed to the main pole column whereby when the shaft of the electric motor rotates, the outdoor television antenna is rotated relative to the main pole.

The VHS antenna elements pivot relative to the main body. The main body comprises positioning bosses that are positioned to hold the VHS antenna elements with a predetermined angle relative to the main body. Each of the positioning bosses comprises a positioning recess that receives the VHS antenna element.

The reflecting unit comprises a parabolic mesh net reflector and two plate reflectors. Each of the plate reflectors comprises a plurality of slots to allow air flow, and a pivoting bracket for attaching the plate reflector to the main body. The pivoting bracket comprises a pivot base that is fixed to the main body and comprises a toothed slot, a pivot panel protruding from the surface of the plate reflector that pivots relative to the pivot base and comprises an elongated positioning slot that is positioned at a first predetermined angle with the surface of the plate reflector, a flat bar that comprises a sliding boss having two teeth that engage with the toothed slot. The flat bar engages with the positing slot when the sliding boss is moved toward the end of the toothed slot, whereby the plate reflectors are fixed at a second predetermined angle relative to the main body.

The antenna circuit separates electric power transferred through the conductive cable and provides the electric power to the electric motor. The antenna circuit comprises a signal booster that boosts the VHF and UHF broadcast signals received by the VHF and UHF antenna elements.

The remote controller comprises a rotation control button for rotation control by a user and emits an infrared light signal according to the operation of the rotation control button, and the control unit comprises an infrared light receptor that receives the infrared signal emitted by the remote controller and sends electric power to the antenna circuit according to the infrared signal.

The UHF antenna elements comprise a plurality of U-shaped conductor wings that are spaced apart with a predetermined interval.

Alternatively, the UHF antenna elements comprise a plurality of X-shaped conductor wings that are spaced apart with a predetermined interval.

Alternatively, the UHF antenna elements comprise a plurality of conductor wings that are enclosed in plastic antenna wing cases. The conductor wings can be moved along a rod attached to the main body whereby the conductor wings are stretched out in an installed state and retracted in a packaged state.

The advantageous effects of the present invention are: (1) the direction of the antenna can be adjusted by 360 degree with an electric motor without manually rotating the pole of the antenna; (2) control signal driving the electric motor is generated via a remote control for a TV to which the antenna is connected, so that the direction of the antenna can be adjusted according to the intention and decision of a user; (3) rotation buttons may be integrated with the TV itself and the remote controller for the TV; (4) packaging size is minimized with the collapsible and retractable arrangement of antenna elements; and (5) broadcast signal reception increases with the multi antenna loop and reflectors.

### BRIEF DESCRIPTION OF THE DRAWINGS

The accompanying drawings illustrate the best embodiments of the present invention. In the drawings:

FIG. 1 is a perspective view showing an outdoor television antenna according to the present invention;

FIG. 2 is an elevation view of a main body;

FIG. 3 is a cross-sectional view of a rotation unit;

FIG. 4 is an exploded plan view of the rotation unit;

FIG. 5 is a plan view of the main body and VHF elements;

FIG. 6 is a cross-sectional view taken along line VI-VI in FIG. 5;

FIG. 7 is an elevation view of the outdoor television antenna;

FIG. 8 is a perspective view of a pivoting bracket;

FIG. 9 is a schematic diagram of an antenna circuit;

FIG. 10 is a perspective view showing alternate shape of UHF antenna elements;

FIG. 11 is a perspective view showing another alternate shape of UHF antenna elements;

FIG. 12 is a perspective view showing a control unit viewed from front; and

FIG. 13 is a perspective view showing the control unit viewed from rear.

### DESCRIPTION OF PREFERRED EMBODIMENTS

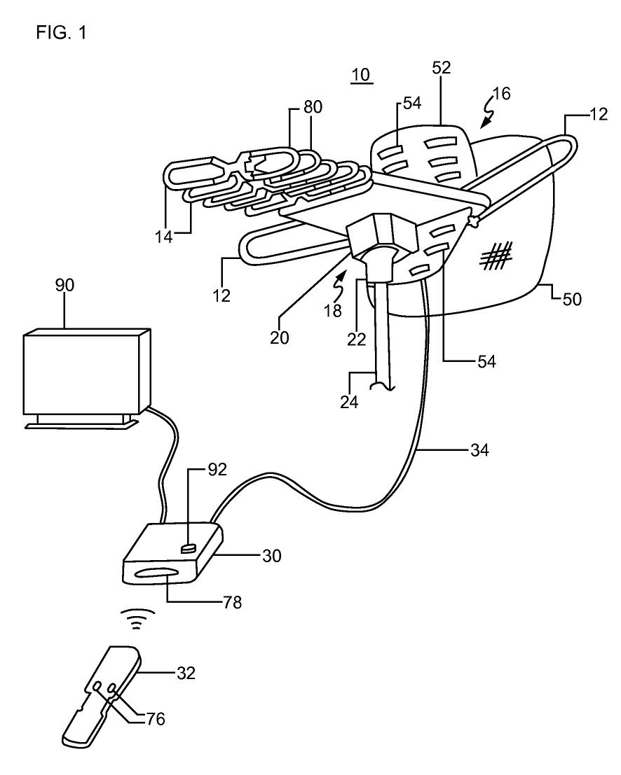

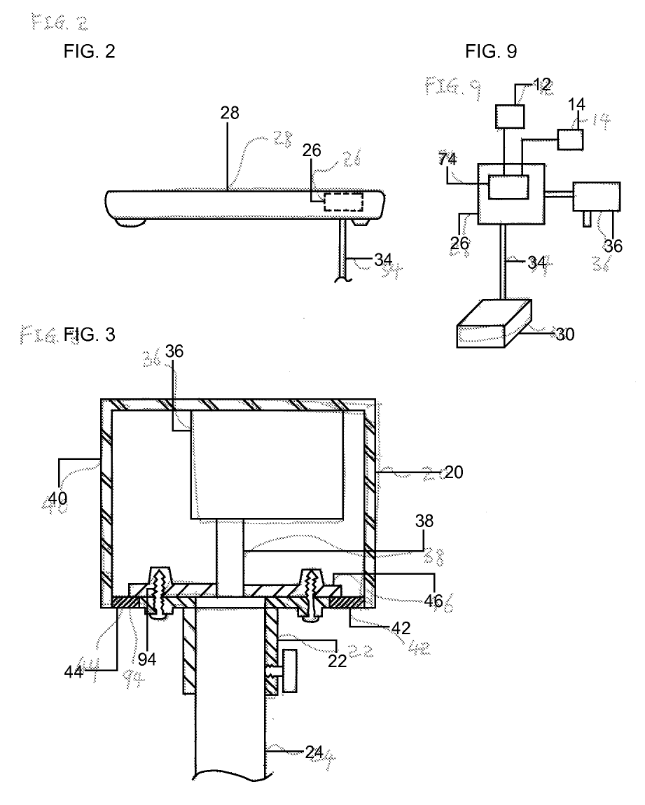

FIG. 1 shows an outdoor television antenna 10 comprising two VHF antenna elements 12 that are adapted to receive VHF broadcast signals, a plurality of UHF antenna elements 14 that are adapted to receive UHF broadcast signals, a reflecting unit 16 that is adapted to reflect broadcast signals, a rotation unit 18 that comprises a motor-fixed bolster 20 and a main pole column (refer to FIG. 3) 22, wherein the main pole column 22 is adapted to fix the outdoor television antenna 10 to a main pole 24, an antenna circuit 26 (refer to FIG. 2) that collects the VHF broadcast signals and the UHF broadcast signals and provides electric power to the rotation unit 18, a main body 28 that supports the VHF antenna elements 12, the UHF antenna elements 14, the reflecting unit 16 and the motor-fixed bolster 20, and encloses the antenna circuit 26, a control unit 30 that relays the VHF and UHF broadcast signals to a television 90 and sends electric power to the antenna circuit 26, a remote controller 32 that sends rotation control signal to the control unit 30 and a conductive cable 34 that, connects the control unit 30 and the antenna circuit 26 and conducts the VHF and UHF broadcast signals and the electric power to power the rotation unit 18. The conductive cable 34 includes a coaxial cable that is commonly used to connect an antenna and a television. The control unit 30 controls rotation of the rotation unit 18, and the motor-fixed bolster 20 rotates the main pole column 22.

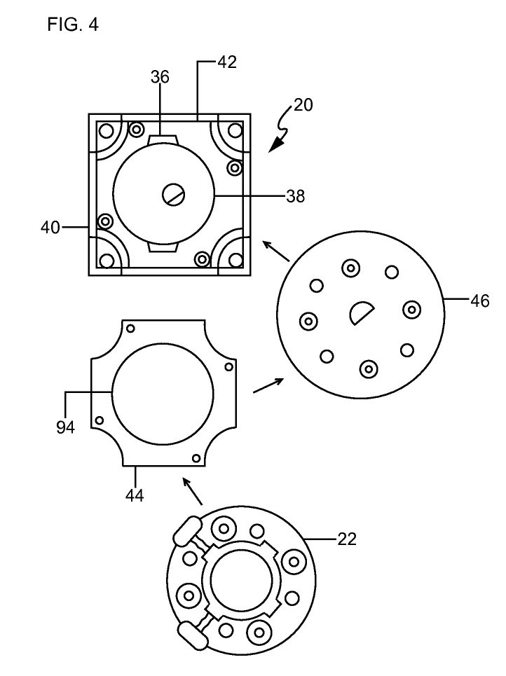

FIGS. 3 and 4 show that the motor-fixed bolster 20 comprises an electric motor 36 that comprises a shaft 38, a housing 40 that encloses the electric motor 36 and comprises an opening 42, a disc support 44 that is attached to the opening 42, a disc 46 that rests upon the disc support 44 and fixed to the shaft 38. The disc support 44 comprises a circular aperture 94 that receives the circumference of the main pole column 22. The disc 46 is fixed to the main pole column 22 whereby when the shaft 38 of the electric motor 36 rotates, the outdoor television antenna 10 is rotated relative to the main pole 24. As shown in FIG. 1, the motor-fixed bolster 20 is attached to the lower side of the main body 28 and thus the inside of the housing 40 does not become wet when it rains.

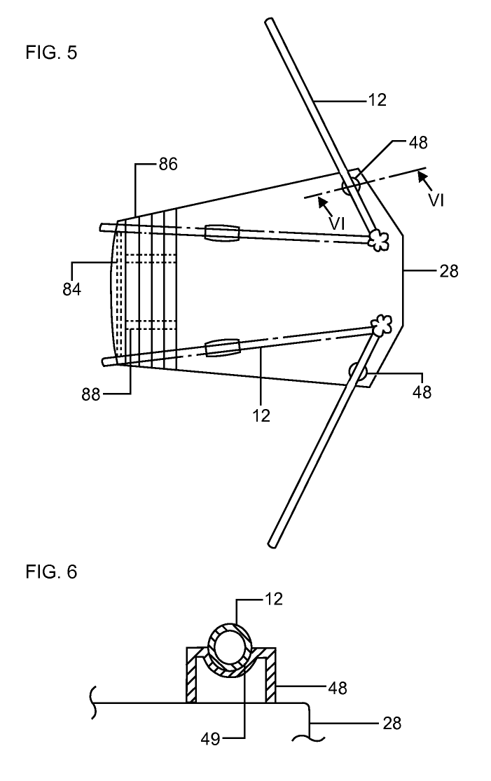

FIG. 5 shows the VHS antenna elements 12 pivot relative to the main body 28. The main body 28 comprises positioning bosses 48 that are positioned to hold the VHS antenna elements 12 with a predetermined angle relative to the main body 28. As shown in FIG. 6, each of the positioning bosses 48 comprises a positioning recess 48 that receives the VHS antenna element 12. This ensures precise and stable positioning of the VHS antenna elements 12.

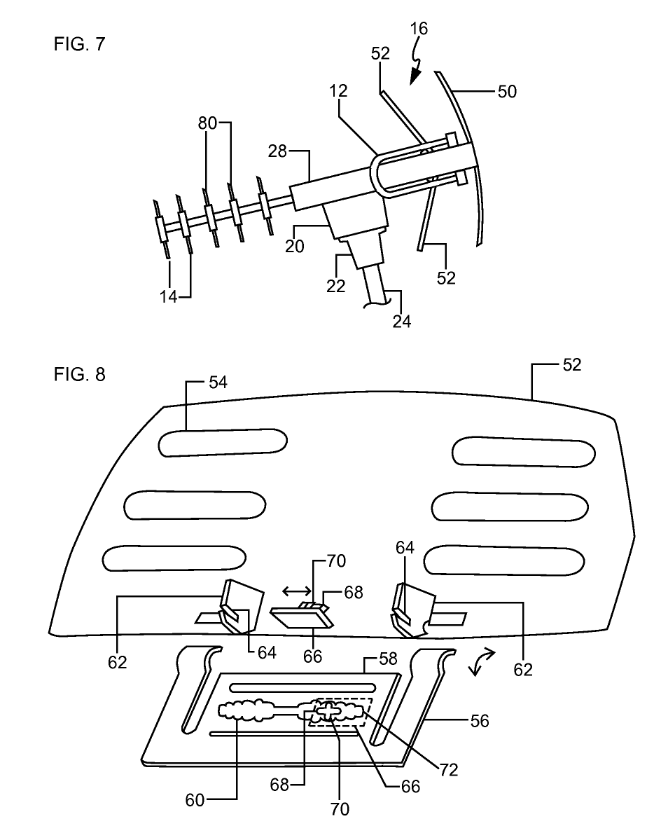

Referring to FIGS. 1 and 7, the reflecting unit 16 comprises a parabolic mesh net reflector 50 and two plate reflectors 52. Each of the plate reflectors 52 comprises a plurality of slots 54 to allow air flow to make the outside television antenna 10 resistant to wind, and a pivoting bracket (refer to FIG. 8) 56 for attaching the plate reflector 52 to the main body 28. The pivoting bracket 56 comprises a pivot base 58 that is fixed to the main body 28 and comprises a toothed slot 60, two pivot panels 62 protruding from the surface of the plate reflector 52, which pivot relative to the pivot base 58 and comprise two elongated positioning slots 64 that are positioned at a first predetermined angle with the surface of the plate reflector 52, two flat bars 66; each of which comprises a sliding boss 68 having two teeth 70 that engage with the toothed slot 60. The flat bars 66 engage with the positing slots 64 when the sliding bosses 68 are moved toward the end 72 of the toothed slot 60, whereby the plate reflectors 52 are fixed at a second predetermined angle relative to the main body 28. In FIG. 8, the pivoting bracket 56, the pivot panels 62 and one of the flat bars 66 are illustrated in non-assembled state to facilitate understanding.

As shown in FIG. 9, the antenna circuit 26 separates electric power transferred through the conductive cable 34 and provides the electric power to the electric motor 36. Therefore a separate cable or wire is not needed to power the rotation unit 18. The antenna circuit 26 comprises a high-gain signal booster 74 that boosts the VHF and UHF broadcast signals received by the VHF and UHF antenna elements 12, 14.

Referring back to FIG. 1, the remote controller 32 comprises two rotation control buttons 76 for rotation control by a user and emits an infrared light signal according to the operation of the rotation control buttons 76, and the control unit 30 comprises an infrared light receptor 78 that receives the infrared signal emitted by the remote controller 32 and sends electric power to the antenna circuit 26 according to the received infrared signal. The control unit 30 also comprises a rotation control button 92. In this way, a user of a TV can adjust the direction of the outside television antenna 10 for best image and sound quality while she is watching the TV. The antenna can also be used to receive FM radio signals. The UHF antenna elements 14 comprise a plurality of U-shaped conductor wings 80 that are spaced apart with a predetermined interval.

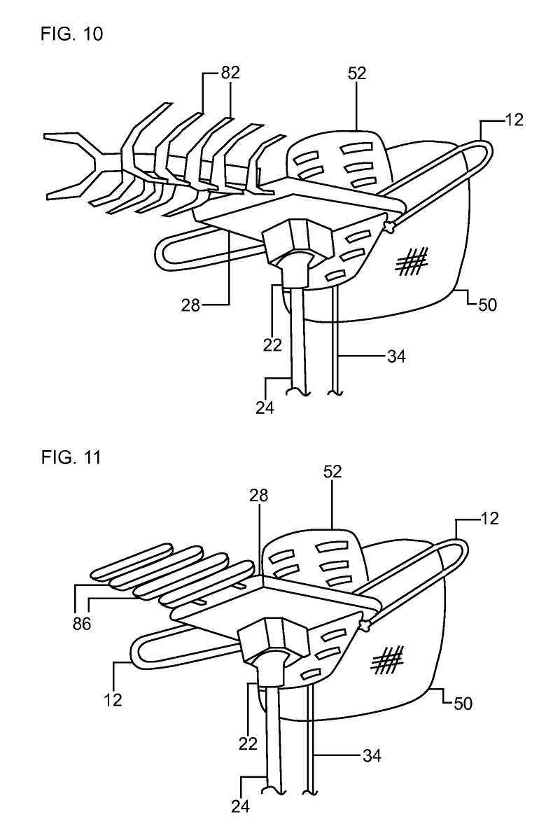

FIG. 10 shows alternate shape of UHF antenna elements that comprise a plurality of X-shaped conductor wings 82 that are spaced apart with a predetermined interval.

FIGS. 5 and 11 show another alternate shape of UHF antenna elements that comprise a plurality of conductor wings 84 that are enclosed in plastic antenna wing cases 86. The conductor wings 84 together with the antenna wing cases 86 can be moved along two rods 88 attached to the main body 24 whereby the conductor wings 84 are stretched out in an installed state (refer to FIG. 11) and retracted in a packaged state (refer to FIG. 5).

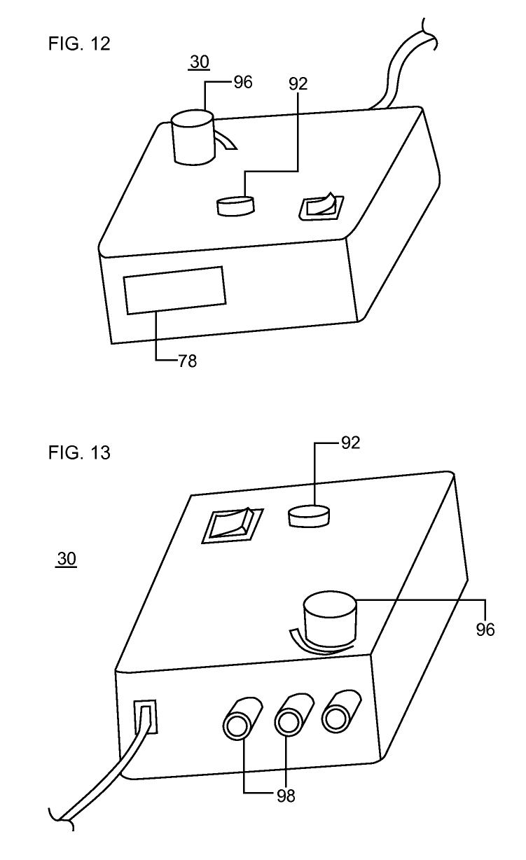

FIGS. 12 and 13 show details of the control unit 30. FIG. 12 shows that the the control unit or controller comprises a gain control 96 that controls degree of boosting UHF or VHF signals. FIG. 13 shows that the control unit 30 comprises connectors 98 to which coaxial cables are connected to relay UHF and VHF signals from the antenna to the television.

1. An outdoor television antenna comprising:
a) one or more VHF antenna elements that are adapted to receive VHF broadcast signals;
b) one or more UHF antenna elements that are adapted to receive UHF broadcast signals;
c) a reflecting unit that is adapted to reflect broadcast signals;
d) a rotation unit that comprises a motor-fixed bolster and a main pole column, wherein the main pole column is adapted to fix the outdoor television antenna to a main pole;
e) an antenna circuit that collects the VHF broadcast signals and the UHF broadcast signals, and provides electric power to the rotation unit;
f) a main body that supports the VHF antenna elements, the UHF antenna elements, the reflecting unit and the motor-fixed bolster, and encloses the antenna circuit;
g) a control unit that relays the VHF and UHF broadcast signals and sends electric power to the antenna circuit; and
h) a conductive cable that connects the control unit and the antenna circuit and conducts the VHF and UHF broadcast signals and the electric power to power the rotation unit;
wherein the control unit controls rotation of the rotation unit, wherein the motor-fixed bolster rotates the main pole column.

2. The outdoor television antenna of claim 1, wherein the motor-fixed bolster comprises an electric motor that comprises a shaft, a housing that encloses the electric motor and comprises an opening, a disc support, that is attached to the opening, a disc that rests upon the disc support and fixed to the shaft, wherein the disc support comprises a circular aperture that receives the circumference of the main pole column, wherein the disc is fixed to the main pole column whereby when the shaft of the electric motor rotates, the outdoor television antenna is rotated relative to the main pole.

3. The outdoor television antenna of claim 2, wherein the VHS antenna elements pivot relative to the main body, wherein the main body comprises positioning bosses that are positioned to hold the VHS antenna elements with a predetermined angle relative to the main body, wherein each of the positioning bosses comprises a positioning recess that receives the VHS antenna element.

4. The outdoor television antenna of claim 3, wherein the reflecting unit comprises a parabolic mesh net reflector and two plate reflectors, wherein each of the plate reflectors comprises a plurality of slots to allow air flow, and a pivoting bracket for attaching the plate reflector to the main body, wherein the pivoting bracket comprises a pivot base that is fixed to the main body and comprises a toothed slot, a pivot panel protruding from the surface of the plate reflector that pivots relative to the pivot base and comprises an elongated positioning slot that is positioned at a first predetermined angle with the surface of the plate reflector, a flat bar that comprises a sliding boss having two teeth that engage with the toothed slot, wherein the flat bar engages with the positing slot when the sliding boss is moved toward the end of the toothed slot, whereby the plate reflectors are fixed at a second predetermined angle relative to the main body.

5. The outdoor television antenna of claim 4, wherein the antenna circuit separates electric power transferred through the conductive cable and provides the electric power to the electric motor.

6. The outdoor television antenna of claim 5, wherein the antenna circuit comprises a signal booster that boosts the VHF and UHF broadcast signals received by the VHF and UHF antenna elements.

7. The outdoor television antenna of claim 6, further comprising a remote controller that sends rotation control signal to the control unit, wherein the remote controller comprises a rotation control button for rotation control by a user and emits an infrared light signal according to the operation of the rotation control button, and the control unit comprises an infrared light receptor that receives the infrared signal emitted by the remote controller and sends electric power to the antenna circuit according to the infrared signal.

8. The outdoor television antenna of claim 7, wherein the UHF antenna elements comprise a plurality of U-shaped conductor wings that are spaced apart with a predetermined interval.

9. The outdoor television antenna of claim 7, wherein the UHF antenna elements comprise a plurality of X-shaped conductor wings that are spaced apart with a predetermined interval.

10. The outdoor television antenna of claim 7, wherein the UHF antenna elements comprise a plurality of conductor wings that are enclosed in plastic antenna wing cases.

11. The outdoor television antenna of claim 10, wherein the conductor wings can be moved along a rod attached to the main body whereby the conductor wings are stretched out in an installed state and retracted in a packaged state.

12. The outdoor television antenna of claim 7, wherein the control unit further comprises a gain control that controls the degree of boosting of UHF or VHF signals.
